(19) United States
(12) Patent Application Publication
(10) Pub. No.: US 2021/0101320 A1
(43) Pub. Date: Apr. 8, 2021

(54) Foaming method by effusing SCF through plastic granules

(71) Applicants: Zhenhuan Lou, Dongguan (CN); Weidong Zhang, Dongguan (CN); Ho Yik, Dongguan (CN)

(72) Inventors: Zhenhuan Lou, Dongguan (CN); Weidong Zhang, Dongguan (CN); Ho Yik, Dongguan (CN)

(21) Appl. No.: 17/115,822

(22) Filed: Dec. 9, 2020

Related U.S. Application Data
(62) Division of application No. 16/207,190, filed on Dec. 3, 2018.

(51) Int. Cl. B29C 44/34; B29C 44/02

(52) U.S. Cl. CPC B29C 44/3453; B29K 2509/00; B29C 44/02

(57) ABSTRACT

A method of microcellular foam molding an article includes feeding plastic granules to a hopper; supplying a supercritical fluid (SCF) to the hopper to effuse through the plastic granules; conveying the effused plastic granules to a mixer; and conveying the effused plastic granules in the mixer to a mold of an injection molding machine to perform foam molding on the effused plastic granules to produce a foamed article. The mold is kept at 10-50° C. and 7-70 Mpa for a foaming time of 50-120 seconds.

### CROSS-REFERENCE TO RELATED APPLICATION

This application is a divisional application of U.S. patent application Ser. No. 16/207,190, entitled “Foaming method by effusing SCF through plastic granules,” filed Dec. 3, 2018, the entire content of which is incorporated herein by reference.

### BACKGROUND OF THE INVENTION

### 1. Field of the Invention

The invention relates to microcellular foam and more particularly to a foaming method by effusing a supercritical fluid (SCF) through plastic granules at a predetermined pressure range and a predetermined temperature range.

### 2. Description of Related Art

Physical or chemical foaming agents are added to polymeric foaming materials to form bubbles therein. The foaming process comprising the steps of forming gas bubbles, nucleation, and stabilization. Typically, gas under high pressure is dissolved into various polymers, relying on thermodynamic instability phenomena to cause the uniform arrangement of the gas bubbles.

Microcellular foam and their methods of manufacturing has become more standardized and improved upon since late 1970s. Trexel Inc. is often referred to as the industry standard for microcellular foam with their use of MuCell®. Molding Technology which is characterized by connecting a device containing a SCF to an injection molding machine (or extrusion press), introducing the SCF into the injection molding machine (or extrusion press) to mix with polymers, and injecting the mixture into a mold. An article is produced after cooling the mold.

However, the conventional MuCell®. Molding Technology has the following disadvantages: greater specific gravity (e.g., more than 0.4), low resilience, poor touch feeling, irregularities on the surface, and being not appropriate for the production of shoes, mats and exercise equipment. Further, using paraffin such as butane, pentane, or hexane or chemical compounds having a lower evaporation temperature as foaming agent is not environment-friendly. Furthermore, conventionally, polyolefin compound or elastomers are foamed externally of a mold prior to placing in the mold. This manufacturing process is time consuming, tedious and not economical.

Still conventionally, foaming internally of a mold has the following disadvantages: springs or the like being liable to damage, breakage and deformation; and the mold being liable to breakage.

Thus, the need for improvement still exists.

### SUMMARY OF THE INVENTION

It is therefore one object of the invention to provide a method of microcellular foam molding an article, comprising the steps of (1) feeding plastic granules to a hopper; (2) supplying a supercritical fluid (SCF) to the hopper to effuse through the plastic granules; (3) conveying the effused plastic granules to a mixer; and (4) conveying the effused plastic granules in the mixer to a mold of an injection molding machine to perform foam molding on the effused plastic granules to produce a foamed article; and wherein in step (4) for no chemical crosslinking, the mold is kept at 10-50° C. and 7-70 Mpa for a foaming time of 50-120 seconds.

The above and other objects, features and advantages of the invention will become apparent from the following detailed description taken with the accompanying drawings.

### BRIEF DESCRIPTION OF THE DRAWINGS

FIG. 1 is a flow chart of a foaming method according to a first preferred embodiment of the invention; and

FIG. 2 is a flow chart of a foaming method according to a second preferred embodiment of the invention.

### DETAILED DESCRIPTION OF THE INVENTION

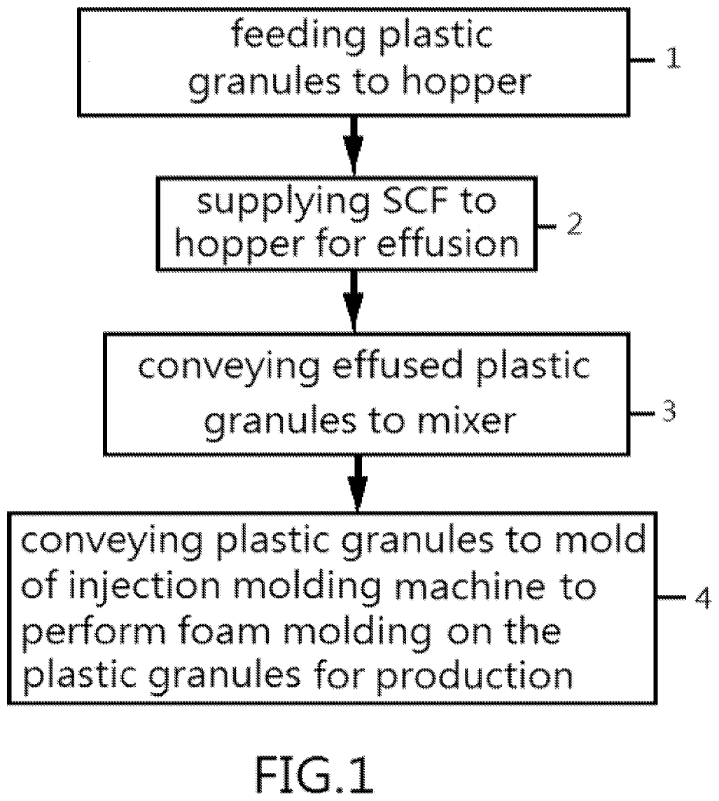

Referring to FIG. 1, a flow chart of a foaming method in accordance with a first preferred embodiment of the invention is illustrated by comprising the following steps as discussed in detail below.

step 1: feeding plastic granules to a hopper;

step 2: supplying an SCF to the hopper to effuse through the plastic granules;

step 3: conveying the effused plastic granules to a mixer; and

step 4: conveying the effused plastic granules in the mixer to a mold of an injection molding machine to perform foam molding on the effused plastic granules to produce a foamed article.

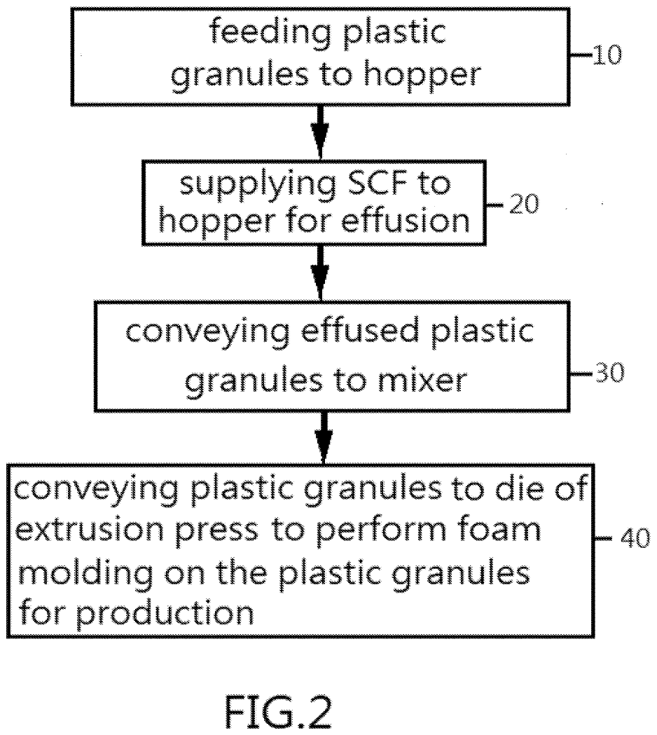

Referring to FIG. 2, a flow chart of a foaming method in accordance with a second preferred embodiment of the invention is illustrated by comprising the following steps as discussed in detail below.

step 10: feeding plastic granules to a hopper;

step 20: supplying an SCF to the hopper to effuse through the plastic granules;

step 30: conveying the effused plastic granules to a mixer; and

step 40: conveying the effused plastic granules in the mixer to a die of an extrusion press to perform foam molding on the effused plastic granules to produce a foamed article.

Referring to both FIGS. 1 and 2 again, the hopper, the mixer, and the injection molding machine (or the extrusion press) are interconnected and are kept at both a predetermined pressure range and a predetermined temperature range.

The plastic granules comprise polyolefin compound and elastomers.

The polyolefin compound comprises at least one of ethylene-vinyl acetate (EVA), polyolefin elastomer (POE), low-density polyethylene (LDPE), ethylene propylene diene monomer (EPDM) rubber. In a first example, EVA is taken as the polyolefin having a 5%-40% mole. In a second example, a combination of EVA and POE having a composition ratio of 100/0.1-0.1/100 is taken as the polyolefin. In a third example, a combination of EVA, POE, and ethylene propylene diene monomer (EPDM) rubber having a composition ratio of 100/0.1/0.1-0.1/100/20.

At least one of crosslinking agent, filler, and chemical additive can be added to the polyolefin compound. The crosslinking agent reacts with molecules of the polyolefin compound to form bridges between polymer molecular links and in turn form an insolvable substance having a three-dimensional structure. The filler can improve performance or reduce production costs. The chemical additive can increase flowability. For the polyolefin compound having 100 parts per hundred rubber (phr), the crosslinking agent has 0.15 phr-1.1 phr or preferably 0.25 phr-1.0 phr, the filler has less than 30 phr, and the chemical additive has less than 10 phr.

The crosslinking agent comprises at least one of daichlorophenols (DCP) and Bis(tert-butylperoxy isopropyl) benzene (BIPB).

Filler comprises at least one of calcium carbonate, pulvistalci, zinc oxide and titanium dioxide.

Chemical additive comprises at least one of paraffin and stearic acid.

Preferably, the elastomers comprise at least one of thermoplastic polyurethane (TPU), thermoplastic polyester elastomer (TPEE), and Pebax® Thermoplastic elastomer.

Examples of the SCF are carbon dioxide, water, methane, ethane, methanol, ethanol, ethylene, propylene, acetone, nitrogen, and a combination thereof.

The effusion occurs in a pressure range of 7-70 Mpa and a temperature range of 35-140° C. for 0.5-8 hours.

Preferably, for polyolefin compound, the effusion occurs in a pressure range of 7-70 Mpa and a temperature range of 30-80° C. for 0.5-8 hours; and preferably, for elastomers the effusion occurs in a pressure range of 7-70 Mpa and a temperature range of 50-130° C. for 1-8 hours.

In the plastic granules effused by SCF, the SCF has a weight percentage of 1-10% (i.e., 1-10 w %).

The mixer is kept at a pressure range of 7-70 Mpa and a temperature range of 0-100° C. Preferably, for polyolefin compound, the mixer is kept at a pressure range of 7-70 Mpa and a temperature range of 0-80° C.; and preferably, for elastomers, the mixer is kept at a pressure range of 7-70 Mpa and a temperature range of 0-100° C.

The mixer is used to temporarily store the effused plastic granules. Otherwise, the effused plastic granules may be effused for an excessive period of time and in turn is prevented from supplying to the injection molding machine (or the extrusion press) for production. Advantageously, the method of the invention makes a continuous supplying of the plastic granules to the injection molding machine (or the extrusion press) possible.

For the plastic granules of polyolefin compound, a chemical crosslinking occurs at the injection molding machine with the mold kept at a predetermined pressure range and a predetermined temperature range.

For the plastic granules of elastomers, no crosslinking occurs. The effused plastic granules are injected into a mold of the injection molding machine.

Preferably, for making the crosslinking possible, the mold is kept at a temperature range of 140-200° C. and a pressure range of 7-70 Mpa for a foaming time (or crosslinking time) of 60-950 seconds.

Preferably, for no crosslinking, the mold is kept at a temperature range of 10-50° C. and a pressure range of 7-70 Mpa for a foaming time of 50-120 seconds.

In the step 40 of conveying the plastic granules in the mixer to a die of an extrusion press to perform foam molding on the plastic granules in which the effused plastic granules are kept at a temperature range of 140-200° C. and a pressure range of 7-70 Mpa.

The foamed article produced by the invention contains billions of tiny bubbles having a size from 0.1 to 3 micrometers and the bubbles have a specific gravity of 0.03-0.30 g/cm³.

In one experiment, the foamed article undergoes three fatigue tests repeatedly with a load of 10-80 kg. It is found that its stability is increased by 30% in comparison with the article made by a conventional EVA foaming material.

The foamed article has a bouncing capability of at least 50% by testing with a ball free falling test based on ASTM D2632. Also, the bouncing capability can be maintained for 10 to 60 days in comparison with the article made by a conventional EVA foaming material. This 10 to 60 days period is increased by 30% in comparison with that of the article made by a conventional EVA foaming material.

The foamed article has many applications including mats, shoes, exercise equipment, toys and packing materials. For a shoe as the produced foamed article of the invention, billions of tiny bubbles of the shoe have a size from 0.1 to 3 micrometers and the bubbles have a specific gravity of 0.05-0.30 g/cm³; and the shoe has a bouncing capability of at least 50% by testing with a ball free falling test based on ASTM D2632. For mat as the produced foamed article of the invention, billions of tiny bubbles of the mat have a size from 0.1 to 3 micrometers and the bubbles have a specific gravity of 0.03-0.20 g/cm³; and the shoe has a bouncing capability of at least 50% by testing with a ball free falling test based on ASTM D2632.

The foaming materials have advantages including low specific gravity, no pollution to the environment, excellent resilience, and smooth surface. The formed article is produced in one process with a great reduction of the manufacturing cost. The step of providing a mixer to temporarily store the effused plastic granules makes a continuous supplying of the plastic granules to the injection molding machine (or the extrusion press) possible. Finally, it not only saves labor but also saves energy.

Embodiment 1: EVA (e.g., EVA7470 produced by Formosa Plastics Corporation) of 100 phr in which ethenyl acetate in the EVA has 26% mole, calcium carbonate of 1 phr, paraffin of 0.5 phr, and DCP of 0.5 phr are added to a mixer to mix for 12 minutes under conditions of 50° C. and 0.7 Mpa. Then a SCF (e.g., carbon dioxide (CO₂)) is effused through the mixture for 2 hours under conditions of 50° C. and 40 Mpa. Plastic granules effused by the SCF are obtained. The effused plastic granules have a foaming ratio of less than 1.5 and the SCF has 10 wt %. The effused plastic granules are temporarily stored in the mixer. In a foam molding step, the effused plastic granules are conveyed from the mixer to a mold of an injection molding machine to perform foam molding by crosslinking the plastic granules for 60-950 seconds under conditions of 140-200° C., 7-70 Mpa. As a result, a foamed article having a smooth surface is produced.

Embodiment 2: EVA is replaced by a compound of EVA (60%)/POE (40%) in which ethenyl acetate in the EVA has 26% mole, and POE having a serial number 8150 is produced by Dows Inc. Other manufacturing steps are the same as that of embodiment 1. The produced article is a foamed article.

The produced foamed article has a specific gravity of 0.13, an average diameter of the bubbles in the produced foamed article is 0.5-2.0 mm, and the bouncing capability of the produced foamed article is 60%.

Embodiment 3: EVA is replaced by a compound of EVA (60%)/POE (40%) in which ethenyl acetate in the EVA has 26% mole, and POE having a serial number 8150 is produced by Dows Inc. Further, CO₂ is replaced by nitrogen as SCF. Other manufacturing steps are the same as that of embodiment 1. The produced article is a foamed article.

The produced foamed article has a specific gravity of 0.15, an average diameter of the bubbles in the produced foamed article is 0.5-2.5 mm, and the bouncing capability of the produced foamed article is 58%.

Embodiment 4: EVA is replaced by a compound of TPU having a serial number 85AU10 produced by Sistron Inc. and the steps of mixing and crosslinking are omitted. Other manufacturing steps are the same as that of embodiment 1. The produced article is a foamed article.

The produced foamed article has a specific gravity of 0.28, an average diameter of the bubbles in the produced foamed article is 0.5-1.5 mm, and the bouncing capability of the produced foamed article is 55%.

Exemplary example 1: The conventional MuCell®. Molding Technology is used in which a SCF foaming device is used to produce TPU foaming articles. Hopper is heated to 210° C. and the mold is heated to 30° C. SCF (e.g., nitrogen) is introduced to the injection molding machine to mix with molten TPU. The molten TPU mixture is injected into a mold cavity to form. The SCF reacts with the molten TPU mixture to form bubbles in the mold cavity.

The produced foamed article has the same size as that of the mold cavity but has irregularities on the surface. The produced foamed article has a specific gravity of 0.4-0.55, an average diameter of the bubbles in the produced foamed article is 0.8-2.0 mm, and the bouncing capability of the produced foamed article is 50%.

Exemplary example 2: except the prefoaming ratio greater than 1.6 after introducing the SCF, other manufacturing steps are the same as that of embodiment 1. The produced article is a foamed article.

The produced foamed article has a specific gravity of 0.22, an average diameter of the bubbles in the produced foamed article is 0.5-1.7 mm, and the bouncing capability of the produced foamed article is 50%.

Exemplary example 3: except the crosslinking agent DCP in the embodiment 1 has 1.25 phr, other manufacturing steps are the same as that of embodiment 1.

The produced article is a foamed article. The produced foamed article has a specific gravity of 0.32, an average diameter of the bubbles in the produced foamed article is 0.2-0.8 mm, and the bouncing capability of the produced foamed article is 40%.

Exemplary example 4: except the crosslinking agent DCP in the embodiment 1 has 0.12 phr, other manufacturing steps are the same as that of embodiment 1. The produced article is a foamed article.

The produced foamed article has a specific gravity of 0.42, an average diameter of the bubbles in the produced foamed article is 0.2-0.6 mm, and the bouncing capability of the produced foamed article is 35%.

Exemplary example 5: except the crosslinking agent DCP in the embodiment 2 has 0.12 phr, other manufacturing steps are the same as that of embodiment 2.

The produced article is a foamed article. The produced foamed article has a specific gravity of 0.35, an average diameter of the bubbles in the produced foamed article is 0.1-0.8 mm, and the bouncing capability of the produced foamed article is 42%.

While the invention has been described in terms of preferred embodiments, those skilled in the art will recognize that the invention can be practiced with modifications within the spirit and scope of the appended claims.

What is claimed is:

1. A method of microcellular foam molding an article, comprising the steps of:
(1) feeding plastic granules to a hopper;
(2) supplying a supercritical fluid (SCF) to the hopper to effuse through the plastic granules;
(3) conveying the effused plastic granules to a mixer; and
(4) conveying the effused plastic granules in the mixer to a mold of an injection molding machine to perform foam molding on the effused plastic granules to produce a foamed article; and wherein in step (4) for no chemical crosslinking, the mold is kept at 10-50° C. and 7-70 Mpa for a foaming time of 50-120 seconds.

2. The method of claim 1, wherein in step (2) the effusion occurs in 7-70 Mpa and 35-140° C. for 0.5-8 hours.

3. The method of claim 1, wherein in step (2) the SCF is carbon dioxide, water, methane, ethane, methanol, ethanol, ethylene, propylene, acetone, nitrogen, or a combination thereof.

4. The method of claim 1, wherein the mixer is kept at 7-70 Mpa and 0-100° C.

5. The method of claim 1, wherein the plastic granules are formed of polyolefin compound.

6. The method of claim 5, wherein the polyolefin compound comprises at least one of ethylene-vinyl acetate (EVA), polyolefin elastomer (POE), low-density polyethylene (LDPE), and ethylene propylene diene monomer (EPDM) rubber.

7. The method of claim 6, further comprising the sub-step of adding at least one of fillers and chemical additives to the polyolefin compound; wherein the fillers comprise at least one of calcium carbonate, pulvistalci, zinc oxide, and titanium dioxide; and the chemical additives comprise at least one of paraffin and stearic acid.

8. The method of claim 7, wherein for the polyolefin compound having 100 phr, the fillers have less than 30 phr and the chemical additives have less than 10 phr.

9. The method of claim 1, wherein the plastic granules are formed of elastomers.

10. The method of claim 9, wherein the elastomers comprise at least one of thermoplastic polyurethane (TPU), thermoplastic polyester elastomer (TPEE), and thermoplastic elastomer.
